(19) United States
(12) Patent Application Publication
(10) Pub. No.: US 2014/0067666 A1
(43) Pub. Date: Mar. 6, 2014

(54) BILLING SYSTEM AND METHOD

(71) Applicant: GENERAL ELECTRIC COMPANY, Schenectady, NY (US)

(72) Inventor: Shawn Arthur McClintic, Erie, PA (US)

(73) Assignee: GENERAL ELECTRIC COMPANY, Schenectady, NY (US)

(21) Appl. No.: 14/018,517

(22) Filed: Sep. 5, 2013

Related U.S. Application Data
(60) Provisional application No. 61/696,940, filed on Sep. 5, 2012.

(51) Int. Cl. G06Q 20/14

(52) U.S. Cl. CPC G06Q 20/14
USPC 705/40

(57) ABSTRACT

Embodiments of the invention include a bill manager component that can identify an ownership of a vehicle and receive an invoice from a third party for a repair on an owned vehicle. The bill manager component can communicate payment for the repair as well as identify an inconsistency in the invoice based on a set of rules. Based on an identified inconsistency, the bill manager component can communicate a refund invoice to the third party.

### CROSS-REFERENCE TO RELATED APPLICATIONS

This application claims the benefit of U.S. Provisional Application Ser. No. 61/696,940, filed Sep. 5, 2012, and entitled “AUTOMATED IDENTIFICATION OF INCORRECT BILLING SYSTEM AND METHOD.” The entirety of the aforementioned application is incorporated herein by reference.

### BACKGROUND

1. Technical Field

Embodiments of the subject matter disclosed herein relate to a billing system and management thereof.

2. Discussion of Art

Repair facilities often utilize Car Repair Billing (CRB), which is a computer-implemented system that facilitates reporting and/or invoicing railroads, car owners, client asset owners, vehicle owners, lessee, lessor, among others. There can be a large number of standardized repairs and costs that correspond to specific repairs made at a repair facility. Moreover, the vehicle owners are responsible for the costs of such repairs as well as validating consistency with the repairs.

It may be desirable to have a system and method that differs from those systems and methods that are currently available.

### BRIEF DESCRIPTION

In an embodiment, a method is provided that includes at least the steps of: comparing an invoice for a repair by a third party for at least one vehicle to an industry-based rule that defines a repair cost for the at least one vehicle; communicating a notice of rebuttal to the third party that includes a disputed cost; paying an invoice related to the repair to the at least one vehicle; and communicating a refund invoice for the disputed cost to the third party.

In an embodiment, a system is provided that can include at least the following: an invoice for a repair made by a third party on a vehicle; a first component that is configured to compare the invoice to an industry-based rule that defines a repair cost for the vehicle; a second component that is configured to communicate a payment for the invoice; a third component that is configured to communicate a notice of rebuttal to the third party, based on the evaluation of the invoice, wherein the notice of rebuttal includes a disputed cost; and a fourth component that is configured to communicate a refund invoice for the disputed cost to the third party.

In an embodiment, a system is provided that includes an invoice for a repair made by a third party on a vehicle. The system can further include a first component that is configured to evaluate the invoice with an Association of American Railroads (AAR) billing rule that defines a standard amount for the repair and a type of the repair. The system can further include a second component that is configured to communicate a payment for the invoice. The system can further include a third component that is configured to generate a notice based on the evaluation of the invoice. The system can further include the third component further configured to communicate the notice to the third party in which the notice indicates a inconsistency with the invoice. The system can further include a fourth component that is configured to communicate a refund invoice to the third party.

In an embodiment, a system is provided that includes means for evaluating a cost with a billing rule, wherein the cost is for a repair made by a third party on a vehicle, and the billing rule is based on at least a standardized amount for the repair and on a type of the repair. The system can include means for communicating payment information associated with a first invoice. The system can include means for communicating a notice that is based at least in part on the invoice to the third party. The system can include means for communicating a refund invoice to the third party. The system can further include means for receiving payment information from the third party in response to the refund invoice.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for generating a refund notice based on an identified inconsistency in an invoice for a repair performed on a vehicle;

FIG. 2 is an illustration of an embodiment of a system for evaluating an invoice for a repair on a vehicle based on an Industry rule or an audit rule;

FIG. 3 is an illustration of an embodiment of a system for integrating an automated repair invoice billing system with Maintenance Management System (MMS);

FIG. 4 is an illustration of an embodiment of a system for integrating an automated repair invoice billing system between two or more owners;

FIG. 5 illustrates a flow chart of an embodiment of a method for generating a refund invoice to a third party based on an identified inconsistency with an invoice for a repair performed on an owned vehicle; and

FIG. 6 illustrates a flow chart of an embodiment of a method for assigning ownership or responsibility for a repair bill for a vehicle.

### DETAILED DESCRIPTION

Embodiments of the invention relate to methods and systems for automating a rebuttal billing system for repairs of a vehicle based on ownership of a vehicle. A bill manager component identifies the ownership of a vehicle and receives an invoice from a third party for a repair on the vehicle. The bill manager component distributes responsibility for the repair based on the ownership identified. Additionally, payment for the repair can be communicated to the third party and any inconsistency in the invoice can be identified based on a set of rules. Based on the identified inconsistency, the bill manager component can communicate a refund invoice to the third party. By way of example and not limitation, the bill manager component can request authorization to send a refund invoice and, upon approval, send the refund invoice. If not approved, an alternative resolution can be pursued by the involved parties.

With reference to the drawings, like reference numerals designate identical or corresponding parts throughout the several views. However, the inclusion of like elements in different views does not mean a given embodiment necessarily includes such elements or that all embodiments of the invention include such elements.

The term “rebuttal process” as used herein can be defined as a process that identifies the responsibility of cost for a repair for a vehicle and distributing the cost amongst the responsible entity or entities. The term “dispute/refund process” as used herein can be defined as a process that evaluates an invoice and requests an evaluation based on the invoice including incorrect repair information. The term “client asset” as used herein means a fixed asset or a mobile asset that is owned and/or operated by a client entity such as, for example, a railroad, a power generation company, a shipping company (e.g., land, sea, air, and/or an combination thereof), a mining equipment company, an airline, or another asset-owning and/or asset-operating entity.

The term “vehicle” as used herein can be defined as an asset that is a mobile machine that transports at least one of a person, people, or a cargo. For instance, a vehicle can be, but is not limited to being, a rail car, an intermodal container, a locomotive, a marine vessel, mining equipment, industrial equipment, construction equipment, and the like. The term “repair facility” as used herein can be defined as a location that evaluates and/or performs a repair on a vehicle or a client asset. The term “Car Repair Billing” (CRB) as used herein can be defined as a computer-implemented system with a portion of software, a portion of hardware, or a combination thereof that facilitates reporting and/or invoicing railroads, car owners, client asset owners, vehicle owners, lessee, lessor, among others. CRB includes Association of American Railroads (AAR) as well as contract billing, and other suitable billing systems for railroads.

The term “Maintenance Management System” (MMS) as used herein can be defined as a computer-implemented system with a portion of software, a portion of hardware, or a combination thereof that facilitates reporting repairs for a vehicle and/or invoicing repairs for a vehicle to railroads, car owners, client asset owners, vehicle owners, lessee, lessor, among others. The MMS can receive a repair from a repair facility. The vehicle owner can use MMS to input repair data received from repair facility and then views, audits, pays, etc. based on the data received.

The term “part” as used herein can be defined as a portion of a client asset and/or a portion of a vehicle, wherein the “part” is involved in a repair for at least one of the client asset or the vehicle. The term “ownership” as used herein can be defined as proof of legal claim to property such as a vehicle. The proof can be a title, a lease agreement, a contract, a legal document, a purchase agreement, among others. The term “component” as used herein can be defined as a portion of hardware, a portion of software, or a combination thereof. A portion of hardware can include at least a processor and a portion of memory, wherein the memory includes an instruction to execute.

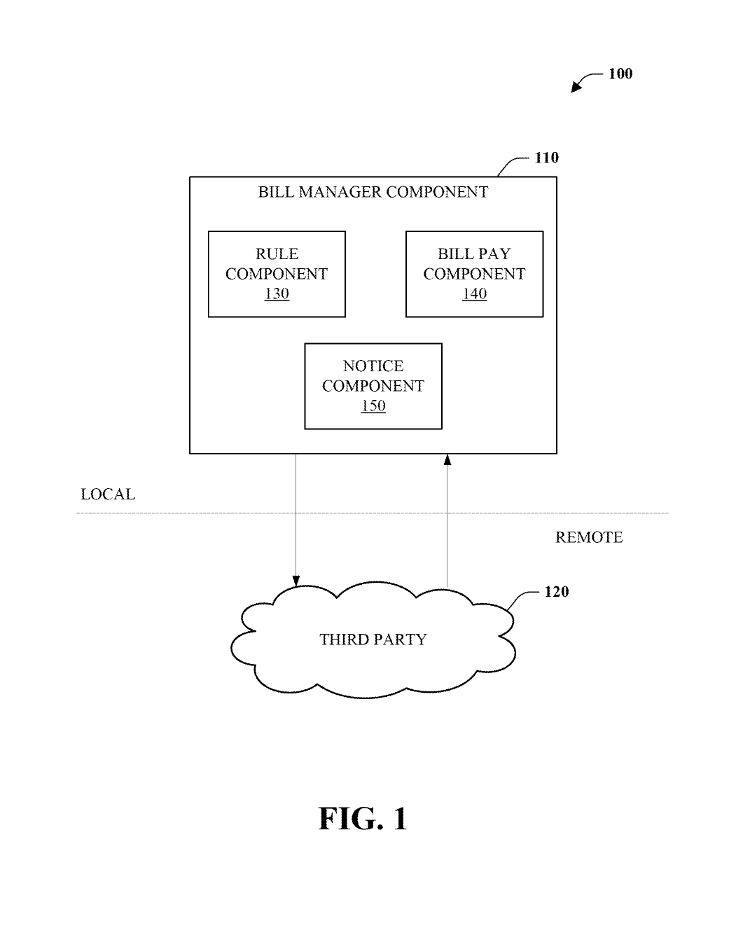

FIG. 1 is an illustration of a system 100 for generating a refund notice based on an identified inconsistency in an invoice for a repair performed a vehicle. The system can include a bill manager component 110 on a local side and a third party 120 on a remote side. The bill manager component can be configured to communicate with the third party in regards to an invoice for a repair performed on a vehicle. The bill manager component provides dispute resolution for inconsistencies identified within the invoice. In another embodiment, the bill manager can identify ownership of a vehicle and assign or distribute payment responsibility based on the ownership or other criteria (e.g., type of repair, custom terms, among others). The third party can be an entity, user, facility, repair facility, repair shop, company, among others that perform a repair on a vehicle. Although the system depicts one third party, there can be more than one third party that performs a repair or a portion of a repair on the vehicle. The invoice for the repair can include one or more repairs, one or more third parties for a repair, multiple repairs from multiple third parties, a third party for a portion of a repair, among others.

The bill manager component can identify an ownership for at least one vehicle. Ownership of a vehicle can be pre-defined, dynamically defined, or a combination thereof. For instance, a user can define vehicle ownership. In another instance, the bill manager component can evaluate data (e.g., electronic records, documents, vehicle information, among others) to ascertain an ownership of a vehicle. Based on the ownership of the vehicle, the bill manager component can manage received invoices for repairs on the vehicles. In an embodiment, the bill manager component can identify a percentage of ownership for each vehicle. In another embodiment, ownership of the vehicle is a factor for identifying a party responsible for a repair invoice and/or a cost for a repair on such vehicle. In another embodiment, the system can utilize ownership as a factor and additional factors (e.g., lessee, lessor, type of vehicle, location of vehicle, type of repair, contract, agreement, among others).

The bill manager component can include a rule component 130 that can be configured to utilize at least one rule related to invoice evaluation. The rule component can import a rule from an industry standard or an industry defined source. For instance, the industry standard or the industry defined source can provide a list of repairs with a fixed price for each repair. By way of example and not limitation, the industry standard or the industry defined source can be the Association of American Railroads (AAR). In an embodiment, the rule component can utilize a custom rule, and the custom rule is defined by a user of the system. For example, an owner of at least one vehicle can utilize the system in order to manage the invoices related to repairs for his or her fleet (e.g., total vehicles). Following the above example, the user may utilize the AAR rules to evaluate an invoice as well as, or in the alternative, a custom rule defined by the user (discussed in more detail below).

The bill manager component can include a bill pay component 140 that can be configured to communicate a payment to the third party based upon an invoice for a repair to at least one vehicle. For instance, the bill pay component can employ an Electronic Funds Transfer (EFS) to the third party based upon the invoice for a performed repair on a vehicle. The bill pay component can evaluate the invoice in order to identify a cost to pay to the third party. In an embodiment, the bill pay component can confirm payment for the invoice via a receipt.

The bill manager component can include a notice component 150 that can be configured to create a refund invoice based on an inconsistency identified with the invoice for a repair on a vehicle. The bill manager component can utilize a rule to compare an invoice from the third party in order to identify an inconsistency or difference between the rule or rules and an invoice. For instance, the invoice can be evaluated based on a repair and a price. Following the industry rule example with the industry rule being an AAR rule for repairs, a set cost is defined for each repair. The bill manager component can compare the invoice with the AAR defined set cost for each repair in order to identify differences or inconsistencies. In an embodiment, the bill pay component can transmit a payment for the repair based on the invoice upon receipt of the invoice or a time shortly thereafter. In another embodiment, the bill pay component can transmit a payment for the repair based on a user or administrator (e.g., approval).

The notice component can generate and, in turn, communicate a refund notice to the third party based on the inconsistency or difference. In an embodiment, the inconsistency or difference is a disputed cost (e.g., a difference in price between the invoice and a price defined in at least one rule). In another embodiment, the inconsistency or difference can be, but not limited to, a type of repair, a necessity of a repair, a technique on how the repair was performed, among others. For instance, the type of repair can be inconsistent based on the vehicle and the repair made thereon (e.g., the particular repair is not to be made on the particular vehicle, among others). In another instance, the necessity of a repair can relate to a scheduled maintenance or a timed maintenance (e.g., preventative maintenance or repair, scheduled repair or work, among others). In another instance, the technique on how the repair can be performed can relate to an order of steps for a repair or a particular style or steps performed for the repair.

The system can be utilized with a suitable Car Repair Billing (CRB) and/or Maintenance Management System (MMS) as well as an environment (e.g., user, repair shop, company, entity, corporation, among others) that employs CRB and/or MMS. In another example, the system 100 can be implemented with an environment that utilizes a suitable billing related to AAR, contract billing, and/or a suitable combination thereof. The rule component, bill pay component, and/or the notice component can be separate components, incorporated into the bill manager component (as illustrated), and/or a suitable combination thereof

The subject invention can provide automated identification of incorrect billing as well as or in the alternative billing that needs to be forwarded on to a third party. The system can be utilized by an owner of a vehicle and/or a repair shop. Under a lease, repairs can be split based on pre-defined repair types, ownership of a vehicle, geographic location of the vehicle, a contract, among others. The system can assign the cost of an invoice for a repair based on that relationship. The system can provide self-defined audit rules for the invoice. For example, an owner of the vehicle can define a rule to analyze a received invoice in addition to a rule from an industry standard (e.g., a rule defined by an industry or organization that defines uniform rules or standards). The defined rules provide an ease of exceptions. The system can provide an automated payment to the invoice for a repair and an evaluation of the invoice in order to identify an inconsistency based on rules. If an inconsistency is identified, the system still pays the invoice but generates a notice (e.g., also referred to as a request for CBA, Counter Billing Request (CBR), among others) that can be communicated to the party responsible for the repair. In response to the notice, a reply to the notice can be received (e.g., also referred to as a CBA, among others). By way of example and not limitation, the bill manager component can request authorization to send a refund invoice and, upon approval, send the refund invoice. If not approved, an alternative resolution can be pursued by the involved parties. Upon settlement, the system can further communicate a refund invoice to the party specifying a refund based on the notice and/or settlement. The system can communicate the notice as well as, or in the alternative the refund invoice to the third party (e.g., a party responsible for the repair on the vehicle).

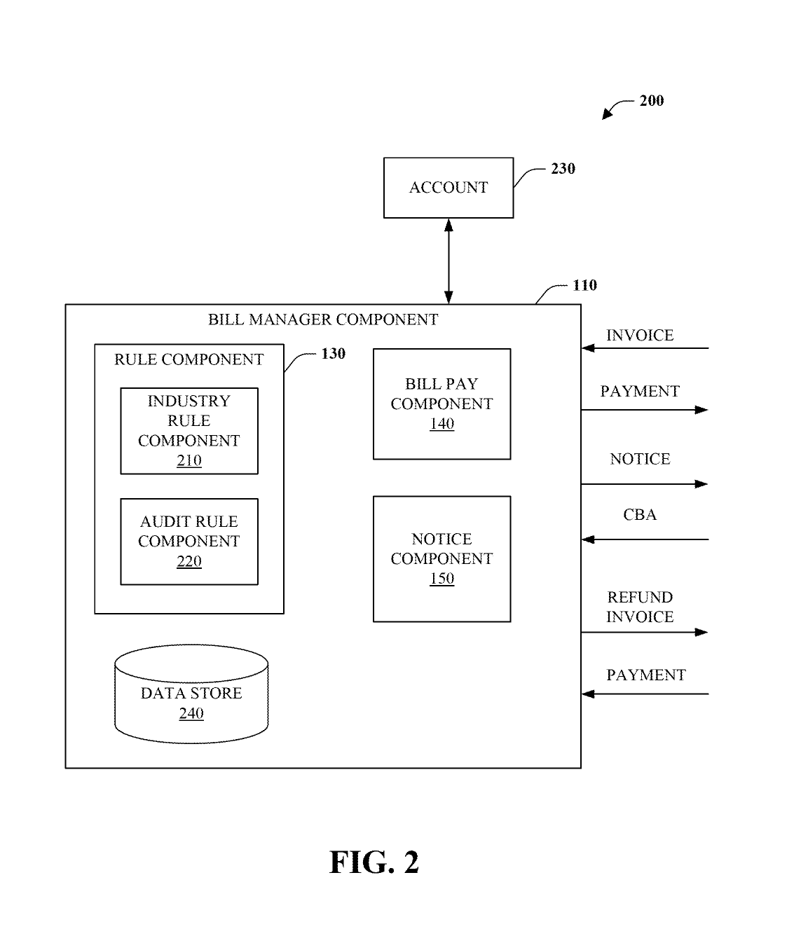

FIG. 2 is an illustration of a system 200 for evaluating an invoice for a repair on a vehicle based on an Industry rule or an audit rule. The system can include the bill manager component that can be configured to maintain consistency between an invoice for a repair performed on a vehicle in comparison to at least one rule. The rule component can define the at least one rule. An industry rule component 230 can leverage a standard set of rules related to an industry regulation, industry rule, a government defined rule, a government regulation, among others. In an embodiment, the industry rule component can define a set of rules that define a repair for a vehicle as well as a corresponding cost for said repair. In another embodiment, the industry rule component can utilize at least one rule from the AAR.

The rule component can include an audit rule component 220 that can be configured to define a custom rule. The audit rule component can be a rule set that is user-defined for his or her specific environment or relationship with the third party. For instance, the audit rule component can define a rule based on historical data of costs and/or repairs, personal preference, individual agreement with a repair facility (e.g., contract billing), geographic location of repair, geographic location of repair facility, type of repair, type of vehicle, quantity of repairs, quantity of vehicles serviced, among others. In another embodiment, the rule component can include a trigger or a threshold (e.g., percentage of difference between rule and invoice, amount of difference between rule and invoice, among others) that initiates a detection of an inconsistency or difference in the evaluation of the rule and the invoice. Moreover, the detection can initiate the communication of a notice (e.g., also referred to as a request for CBA, Counter Billing Request (CBR), among others) (discussed in more detail below).

The rule component can evaluate an invoice for a performed repair on a vehicle with at least one rule. For instance, an invoice can be received from the third party (not shown) in which the invoice details a repair for a vehicle and a cost for a vehicle. The rule component can evaluate the invoice and determine the invoice is consistent with the at least one rule (e.g., no inconsistency, no difference). In such a scenario, the bill manager component can provide payment for the invoice without a dispute (e.g., discussed below). The rule component can monitor the invoice (and/or incoming invoices) from one or more third parties to locate a violation of a rule (via the rule component).

Upon a detected violated rule on an invoice, the bill pay component can initiate a payment for the invoice. The bill pay component can access an account 230 in order to allocate funds to pay to the third party (not shown). The account can be accessed in order to provide an EFS, a wire transfer, a check, among others to the third party based on the invoice received for the repair on the vehicle.

The notice component can communicate a notice (also referred to as a request for CBA, a CBR among others) to the third party based on the detection of a violation of at least one rule (e.g., evaluation of at least one rule and the received invoice from the third party). The notice can be an electronic communication that includes, for instance, a disputed cost, the detected violation of a rule, details related to the inconsistency identified, among others. The rebuttal billing process can be independent of a dispute/refund process. In an embodiment, the rebuttal billing process can be incorporated with the dispute/refund process. In an embodiment, the rebuttal billing process can be isolated and independent of the dispute/refund process. In an embodiment, the rebuttal billing process and the dispute/refund process can be stand-alone systems, incorporated together, or a combination thereof. In an embodiment, the notice is communicated to the third party and the sender of the notice and the third party can negotiate a settlement or agreement. In another embodiment, a communication from a Counter Billing Authority (CBA) is received by the bill manager component in response to the transmitted notice.

In an embodiment, the rebuttal process can be independent from the dispute/refund process in which the bill manager can implement at least one of the rebuttal process or the dispute refund process. Although the bill manager component is described as employing the rebuttal process and the dispute/refund process, the subject innovation can employ the rebuttal process alone or in combination of the dispute/refund process and/or the dispute/refund process alone or in combination of the rebuttal process.

For instance, the rebuttal billing process is used when the responsibility for a repair is split amongst multiple parties. The following is an example of rebuttal billing process and is solely for illustrative purposes. For example, entity “A” owns a vehicle and leases that vehicle to entity “B”. Entity A and B agree that B will be responsible for all gate repairs to vehicle, and entity A will be responsible for all other repairs. When a repair bill is received for entity B, for example, entity B will pay the repairing party the entire invoice amount. Then entity B will identify all repairs on the vehicle that are not repairs to gates and pass an invoice along to entity A for those repairs. The bill manager component can automatically identify the repairs that are entity B′s responsibility versus entity A′s responsibility. The bill manager component can identify responsibility of repairs and distribute the repairs to the responsible entity.

The dispute/refund process is used when someone receives an invoice with incorrect repairs. The following is an example of dispute/refund process and is solely for illustrative purposes. For example, entity A owns a vehicle. Entity B sends entity A an invoice for a repair. Entity A pays the invoice and loads the invoice into the bill manager component. The bill manager component audits the bill/invoice automatically based on industry rule and/or a custom rule. Based on the audit, entity A can confirm incorrect repairs. Entity A can communicate a dispute request to entity B describing the incorrect repairs and requesting entity B's approval to invoice entity B in the amount of the incorrect repairs (essentially a refund). Entity B approves or rejects this request. If entity B approves, then entity A subsequently invoices entity B for that amount and get “refunded” the payment. The bill manager can employ such dispute/refund process.

In an embodiment, the notice can provide a settlement or a negotiated agreement between the bill manager component and the third party. In another embodiment, the third party can evaluate and ascertain the authenticity of the notice (e.g., either agreeing or disagreeing). If the third party agrees to the notice and/or a settlement is reached, the bill manager component can communicate or transmit a refund notice, wherein the refund notice includes, but is not limited to including, a third party address, an invoice identification (e.g., invoice number, detail of repairs, among others), a repair, a vehicle identification, a disputed cost, an amount of funds that are owed, among others. The refund notice can be communicated electronically, for instance. Based on the refund notice communicated to the third party (e.g., the party that sent the invoice with the inconsistency detected), the third party can communicate a payment for the disputed cost identified in the refund notice.

In an embodiment, the bill manager component stores information related to the systems 100, 200, and/or 300 with a data store 240. The data store can include information such as, but not limited to, an invoice, a repair cost, a type of repair, information related to a vehicle, ownership of a vehicle, a rule, an industry rule, a custom rule, an account, information related to an account, historical data related to an invoice, historical data related to a cost for a repair, information related to a repair facility, address of repair facility, among others, and/or a suitable combination thereof

The data store can be, for example, either volatile memory or nonvolatile memory, or can include both volatile and nonvolatile memory. The data store of the subject systems and methods is intended to comprise, without being limited to, these and other suitable types of memory. In addition, the data store can be a server, a database, a hard drive, a flash drive, an external hard drive, a portable hard drive, a cloud-based storage, and the like.

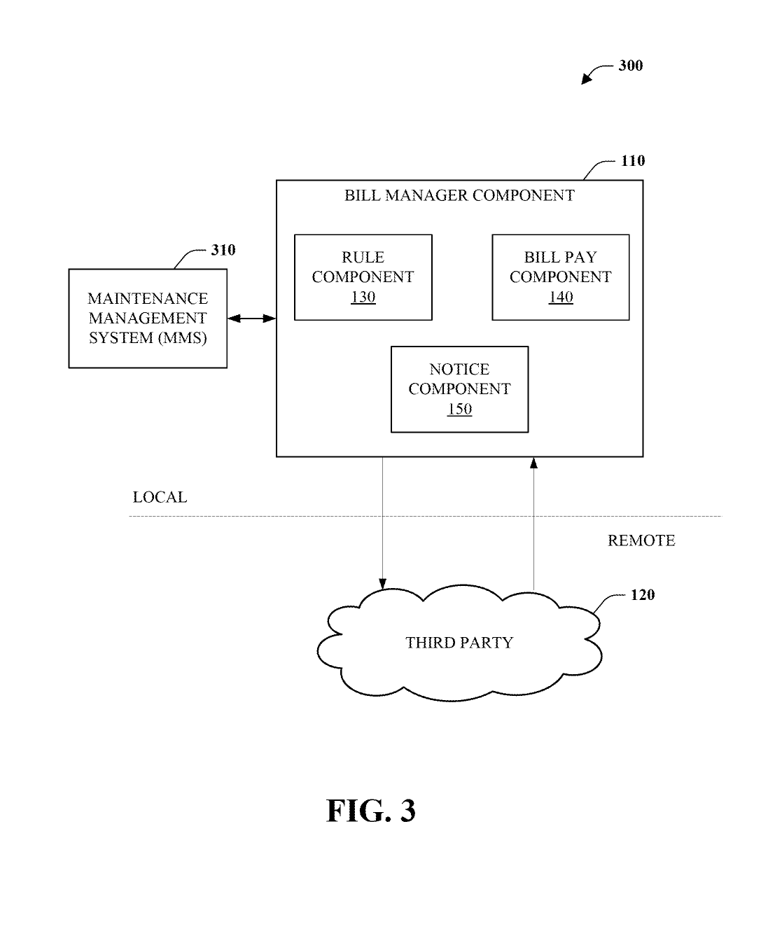

FIG. 3 is an illustration of a system 300 for integrating an automated repair invoice billing system with a Maintenance Management System (MMS) 310. The system 300 can include the bill manager component that can be configured to receive, collect, or aggregate an invoice from the MMS, wherein the invoice can include information related to a repair performed on at least one vehicle. In an embodiment, the invoice is communicated to the bill manager component and sorted based on an ownership of a vehicle to which the repair was performed. For instance, the MMS can be associated with a CRB (not shown).

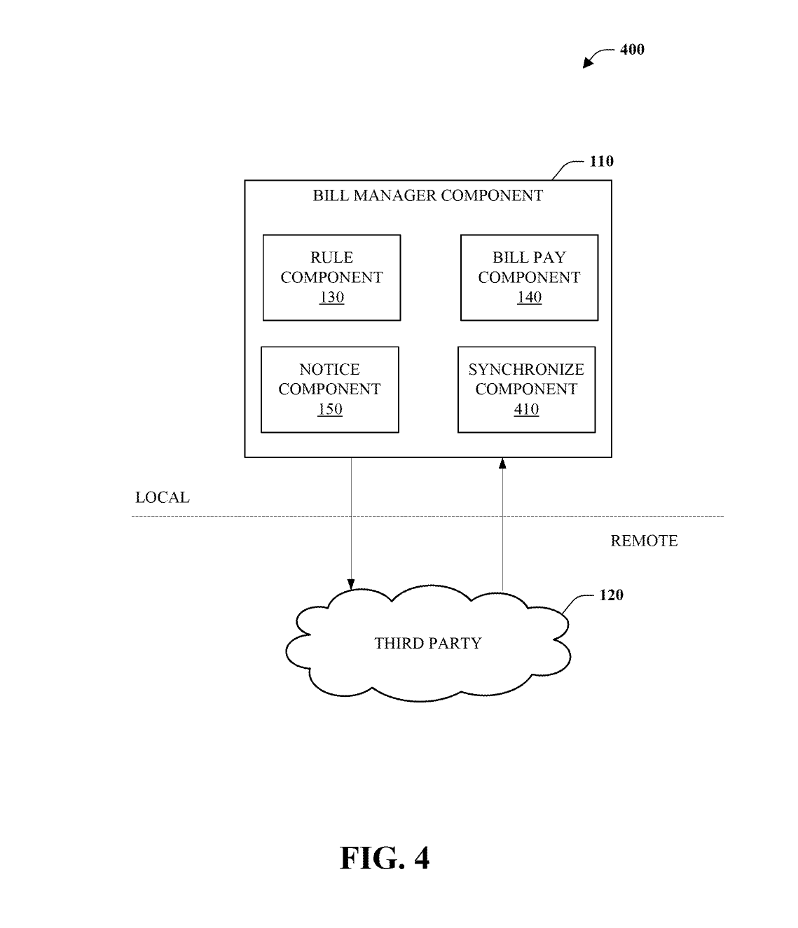

FIG. 4 is an illustration of a system 400 for integrating an automated repair invoice billing system between two or more owners. The system can include the bill manager component that includes a synchronize component 410. The synchronize component can be configured to maintain a rule from a first user or entity is utilized with a second user or entity. The synchronize component can maintain a uniformity between one or more users/entities of the system.

For example, a first owner and a second owner can share a percentage interest in a vehicle to which an agreement states repairs are split. However, the invoice for the vehicle can be communicated to either the first owner or the second owner. The first owner and the second owner (both utilizing the system 400) can implement the synchronize component to maintain consistency between rules for invoices and ensuring uniformity. The rules and evaluation of the invoices for the first owner and the second owner can be uniform which enables the third party (e.g., sender of invoice, repair shop, repair facility, among others) to receive accurate payments, notices, and/or refund invoices.

The aforementioned systems, components (e.g., bill manager component, among others), and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

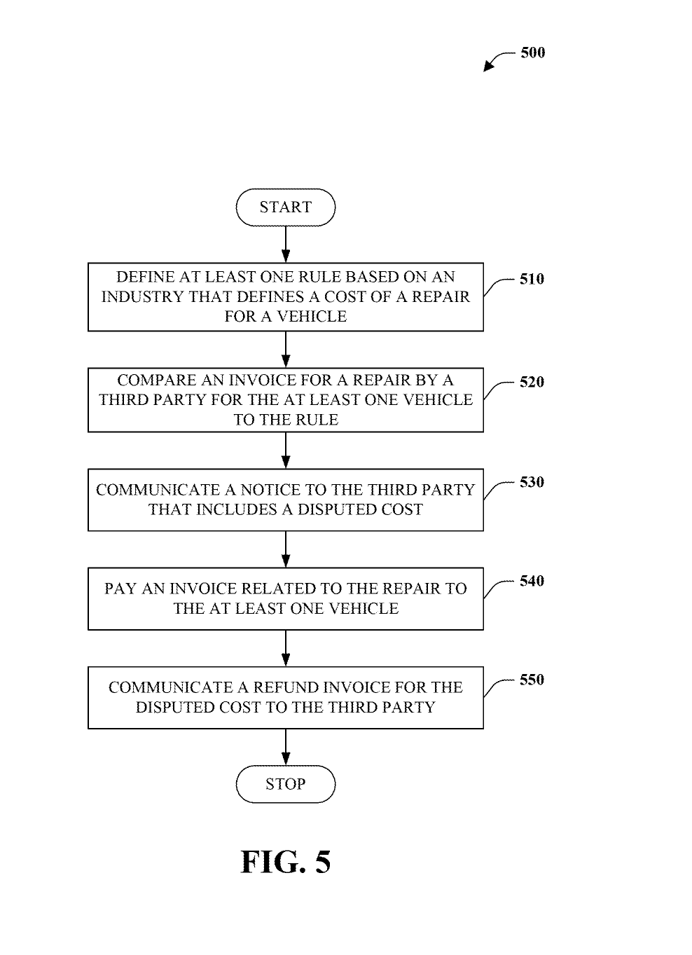

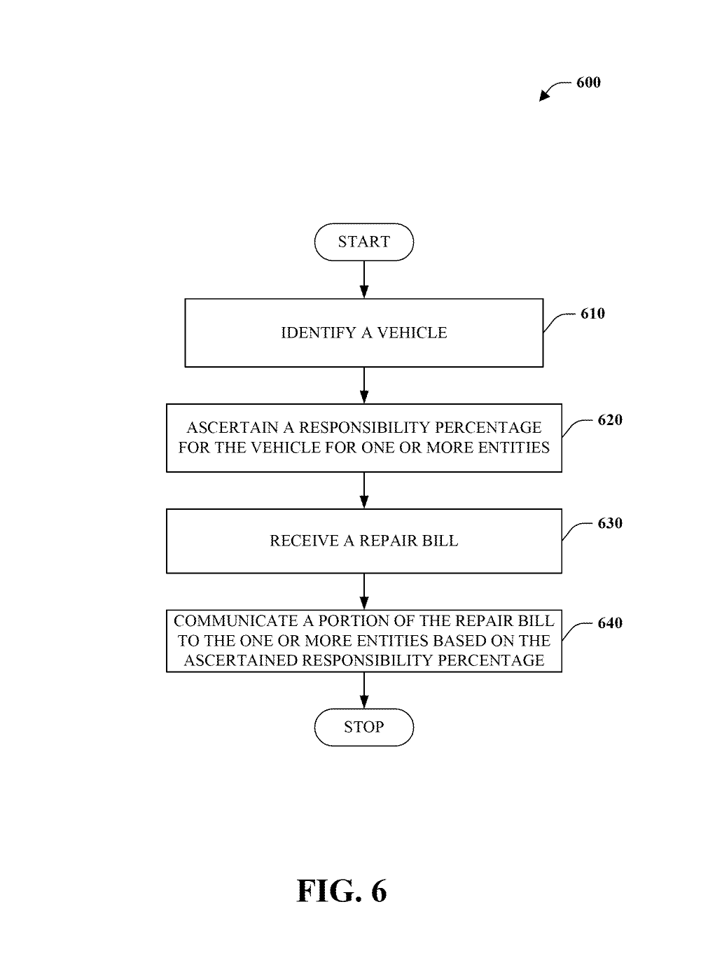

In view of the exemplary devices and elements described supra, methodologies that may be implemented in accordance with the disclosed subject matter will be better appreciated with reference to the flow charts of FIGS. 5 and 6. The methodologies are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods described hereinafter. The methodologies can be implemented by a component or a portion of a component that includes at least a processor, a memory, and an instruction stored on the memory for the processor to execute.

FIG. 5 illustrates a flow chart of a method 500 for generating a refund invoice to a third party based on an identified inconsistency with an invoice for a repair performed on an owned vehicle. At reference numeral 510, at least one rule based on an industry that defines a cost of a repair for a vehicle can be defined. For instance, the industry can be Association of American Railroads (AAR). At reference numeral 520, an invoice for a repair by a third party for the at least one vehicle can be compared to the rule. For example, the comparison can identify a difference, an inconsistency, among others. At reference numeral 530, a notice of rebuttal can be communicated to the third party, wherein the notice of rebuttal includes a disputed cost. The rebuttal billing process (e.g., communicating a notice based on an inconsistency in a bill or repair) can be independent of a dispute/refund process (e.g., communication of refund notice, approval to send refund notice, receipt of payment, among others). In an embodiment, the rebuttal billing process can be incorporated with the dispute/refund process. In an embodiment, the rebuttal billing process can be isolated and independent of the dispute/refund process. In an embodiment, the rebuttal billing process and the dispute/refund process can be stand-alone systems, incorporated together, or a combination thereof. At reference numeral 540, an invoice related to the repair to the at least one vehicle can be paid. At reference numeral 550, a refund invoice for the disputed cost can be communicated to the third party. The method 500 can further include receiving a payment from the third party in response to the refund invoice.

The method further includes defining an additional rule based on an owner of the at least one vehicle. For instance, the additional rule can be based on at least one of a type of the repair, the third party, a geographical location of the at least one vehicle, a previous invoice, a previous payment for the repair, among others. The method can further include negotiating the disputed cost between an owner of the at least one vehicle and the third party. The method can further include receiving the invoice from a maintenance management system (MMS). For instance, the industry can be an Association of American Railroads (AAR). Furthermore, the method can include receiving a payment for the refund invoice from the third party.

The method can further include receiving a Counter Billing Authority (CBA) communication in response to the communication of the notice of rebuttal. The method can further include communicating the refund invoice for the disputed cost to the third party based on the CBA. For instance, at least one of the notice of rebuttal or the refund invoice is an electronic communication. The method can further include distributing a payment received in response to the refund invoice based upon ownership of the at least one vehicle. The method of the subject disclosure can further include assigning a percentage of ownership for the at least one vehicle to at least one of a user, an entity, a corporation, a business entity, among others. The method can further include paying the invoice with an Electronic Funds Transfer (EFS) payment.

FIG. 6 illustrates a flow chart of a method 600 for assigning ownership or responsibility for a repair bill for a vehicle. At reference numeral 610, a vehicle can be identified. For instance, the vehicle can be identified via a computer or a manual input of the vehicle or a combination thereof. At reference numeral 620, a responsibility percentage for the vehicle can be ascertained for one or more entities (e.g., user, company, corporation, business, third-party, among others). For instance, the ownership of a plurality of vehicles can be evaluated in order to assign a percentage of ownership for each. For instance, a user can define vehicle ownership. In another instance, data (e.g., electronic records, documents, vehicle information, among others) can be evaluated to ascertain an ownership of a vehicle. At reference numeral 630, a repair bill can be received. For instance, the repair bill can be received electronically, via email, mail, among others. The repair bill can be received and manually entered into the system (e.g., keyboard, scanning, among others). At reference numeral 640, a portion of the repair bill is communicated to the one or more entities based on the ascertained responsibility percentage. For instance, the communication can be an invoice, a bill, a notice, an email, among others that indicates a responsibility to pay or handle the allocated percentage of the repair bill. In another embodiment, the percentage of ownership can be used as a factor with additional factors (e.g., lessee, lessor, type of vehicle, location of vehicle, type of repair, contract, agreements, among others) to assign responsibility of the repair bill.

In an embodiment, a device, component, and/or processor can perform the following: comparing an invoice for a repair by a third party for at least one vehicle to an industry-based rule that defines a repair cost for the at least one vehicle; communicating a notice of rebuttal to the third party that includes a disputed cost; paying an invoice related to the repair to the at least one vehicle; and communicating a refund invoice for the disputed cost to the third party.

In an embodiment, a system is provided that can include at least the following: means for evaluating a cost with a billing rule, and the cost is for a repair made by a third party on a vehicle, and the billing rule is based on at least a standardized amount for the repair and on a type of the repair (e.g., via the rule component, the bill manager component, among others); means for communicating payment information associated with a first invoice (e.g., via the bill pay component, the bill manager component, among others); means for communicating a notice that is based at least in part on the invoice to the third party (e.g., via the notice component, the bill manager component, among others); means for communicating a refund invoice to the third party (e.g., via the bill manager component, among others); and means for receiving payment information from the third party in response to the refund invoice (e.g., via the bill pay component, the bill manager component, among others).

In another embodiment, a system comprises: means for evaluating a cost with a billing rule, and the cost is for a repair made by a third party on a vehicle, and the billing rule is based on at least a standardized amount for the repair and on a type of the repair; means for communicating payment information associated with a first invoice; means for communicating a notice that is based at least in part on the invoice to the third party; means for communicating a refund invoice to the third party; and means for receiving payment information from the third party in response to the refund invoice.

In the specification and claims, reference will be made to a number of terms that have the following meanings The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method, comprising:
comparing an invoice for a repair by a third party for at least one vehicle to an industry-based rule that defines a repair cost for the at least one vehicle;
communicating a notice of rebuttal to the third party that includes a disputed cost;
paying an invoice related to the repair to the at least one vehicle; and
communicating a refund invoice for the disputed cost to the third party.

2. The method of claim 1, further comprising defining an additional rule based on an owner of the at least one vehicle.

3. The method of claim 2, wherein the additional rule is based on at least one of a type of the repair, the third party, a geographical location of the at least one vehicle, a previous invoice, or a previous payment for the repair.

4. The method of claim 1, further comprising negotiating the disputed cost between an owner of the at least one vehicle and the third party.

5. The method of claim 1, further comprising receiving the invoice from a Maintenance Management System associated with a Car Repair Billing.

6. The method of claim 1, wherein the industry is an Association of American Railroads.

7. The method of claim 1, further comprising receiving a payment for the refund invoice from the third party.

8. The method of claim 1, further comprising receiving a Counter Billing Authority (CBA) communication in response to the communication of the notice of rebuttal.

9. The method of claim 8, further comprising communicating the refund invoice for the disputed cost to the third party based on the CBA.

10. The method of claim 1, wherein at least one of the notice of rebuttal or the refund invoice is an electronic communication.

11. The method of claim 1, further comprising distributing a payment received in response to the refund invoice based upon ownership of the at least one vehicle.

12. The method of claim 1, further comprising assigning a percentage of ownership for the at least one vehicle to at least one of a user, an entity, or a business entity.

13. The method of claim 1, further comprising paying the invoice with an Electronic Funds Transfer payment.

14. A system, comprising:
an invoice for a repair made by a third party on a vehicle;
a first component that is configured to compare the invoice to an industry-based rule that defines a repair cost for the vehicle;
a second component that is configured to communicate a payment for the invoice;
a third component that is configured to communicate a notice of rebuttal to the third party, based on the evaluation of the invoice, wherein the notice of rebuttal includes a disputed cost; and
a fourth component that is configured to communicate a refund invoice for the disputed cost to the third party.

15. A system, comprising:
an invoice for a repair made by a third party on a vehicle;
a first component that is configured to evaluate the invoice with an Association of American Railroads (AAR) billing rule that defines a standard amount for the repair and a type of the repair;
a second component that is configured to communicate a payment for the invoice;
a third component that is configured to generate a notice based on the evaluation of the invoice;
the third component is further configured to communicate the notice to the third party in which the notice indicates a inconsistency with the invoice; and
a fourth component that is configured to communicate a refund invoice to the third party.

16. The system of claim 15, further comprising a fifth component configured to create a rule based on an owner of the vehicle, wherein the rule is based on at least one of a type of the repair, the third party, a geographical location of the at least one vehicle, a previous invoice, or a previous payment for the repair.

17. The system of claim 15, further comprising a Maintenance Management System associated with a Car Repair Billing that communicates the invoice to an owner of the vehicle.

18. The system of claim 15, wherein at least one of the notice or the refund invoice is an electronic communication.

19. The system of claim 15, wherein the first component is further configured to identify a difference between the invoice and at least one of the Association of American Railroads (AAR) billing rules.

20. The system of claim 15, wherein the second component is further configured to receive a payment from the third party in response to the refund invoice.
